(19) United States
(12) Patent Application Publication
(10) Pub. No.: US 2010/0307235 A1
(43) Pub. Date: Dec. 9, 2010

(54) AIRCRAFT FUEL TANK WEIGHT MEASUREMENT APPARATUS AND METHOD

(75) Inventors: Franklin TICHBORNE, Bristol (GB); Simon MASTERS, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS OPERATIONS LIMITED, Bristol (GB)

(21) Appl. No.: 12/793,072

(22) Filed: Jun. 3, 2010

(30) Foreign Application Priority Data
Jun. 3, 2009 (GB) 0909512.6

(51) Int. Cl. G01F 23/284; G01G 19/08; G01G 19/12

(52) U.S. Cl. 73/290 R; 177/136; 177/1

(57) ABSTRACT

An aircraft fuel tank weight measurement apparatus comprising a first solid element defining a load path for an aircraft fuel tank, an EMW emitter and an EMW detector arranged such that a first EM wave from the EMW emitter to the EMW detector passes through the first solid element, the detector arranged to detect a phase shift in the first wave resulting from a change in length of the first wave path caused by deformation of the first solid element.

The present invention is concerned with an aircraft fuel tank weight measurement apparatus. More specifically, the present invention is concerned with the measurement of auxiliary fuel tank weight in an aircraft, and thereby measurement of the amount of fuel therein.

Auxiliary fuel tanks in aircraft are positioned within the fuselage. The level of fuel in aircraft auxiliary fuel tanks is traditionally measured by submersed fuel level detectors, which can detect a level of fuel at a known position within a tank. Such detectors may comprise capacitive or ultrasonic probes for example.

A problem with such known detectors is that they have to be installed within the tank itself. Therefore there has to be a conduit running from the interior to the exterior of the tank in order for the fuel level detector to be connected to an appropriate gauge or computer.

It is desirable to have a continuous reading of the fuel level. Therefore, instantaneous sensors such as piezoelectric elements which produce a current proportional to induced strain cannot be used. This is because the charge decays without a change in strain. Therefore, piezoelectric devices suffer the problem that continuous reading of the fuel level is not possible.

It is an aim of the present invention to provide an improved weight measurement apparatus and method.

According to a first aspect of the invention there is provided a an aircraft fuel tank weight measurement apparatus comprising a first element defining a load path for an aircraft fuel tank, an electromagnetic wave emitter and an electromagnetic wave detector arranged such that a first electromagnetic wave passes from the electromagnetic wave emitter to the electromagnetic wave detector through the first element to define a first wave path, the detector arranged to detect a change in length of the first wave path caused by a dimensional change of the first element.

By electromagnetic wave emitter, we mean a wave emitter capable of producing a coherent, single frequency electromagnetic wave.

Advantageously, the apparatus does not require any intrusion into the fuel tank itself, rather only to be positioned in the load path between the fuel tank and the fuselage. Further, a continuous reading is possible as long as the electromagnetic wave emitter is activated.

According to a second aspect of the present invention there is provided a method of measuring the weight of an aircraft fuel tank, comprising the steps of providing an aircraft fuel tank, providing a first element at least partially supporting the aircraft fuel tank, providing an electromagnetic wave emitter and an electromagnetic wave detector, positioning the electromagnetic wave emitter and the electromagnetic wave detector such that a first electromagnetic wave from the electromagnetic wave emitter to the electromagnetic wave detector passes through the first element, using the detector to determine a pre-load characteristic of the first electromagnetic wave, changing the weight of the aircraft fuel tank, using the detector to determine a post-load characteristic of the first electromagnetic wave, determining the phase shift between the pre- and post-load characteristics resulting from a dimensional change of the first solid element to establish the change in weight of the aircraft fuel tank.

The step of changing the weight of the aircraft fuel tank includes the addition or removal of fuel.

An example apparatus and method in accordance with the present invention will now be described with reference to the accompanying figures in which:

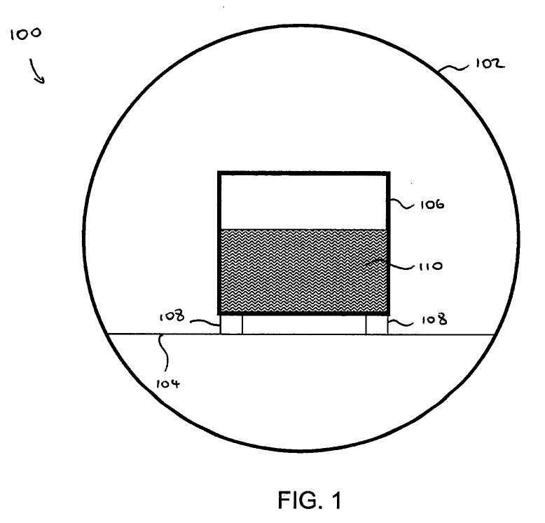

FIG. 1 is a section view of an aircraft fuselage with a fuel tank positioned therein;

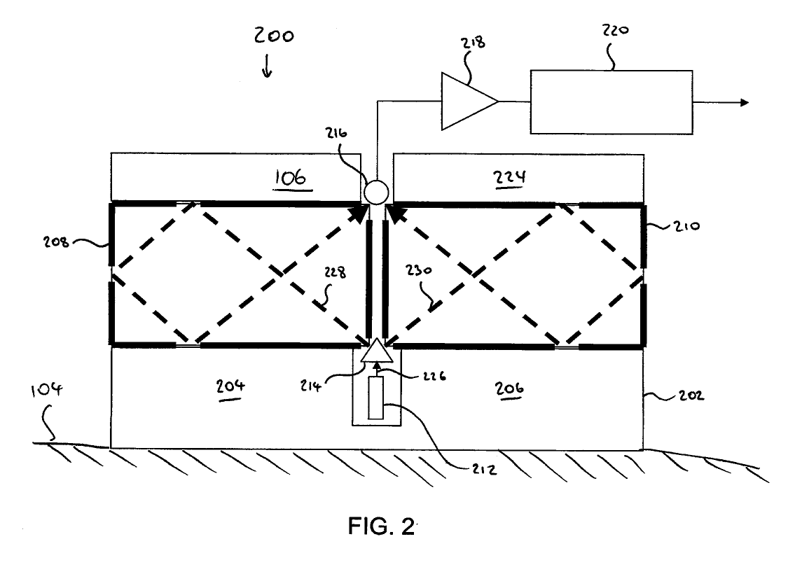

FIG. 2 is a schematic view of an unloaded apparatus in accordance with the present invention,

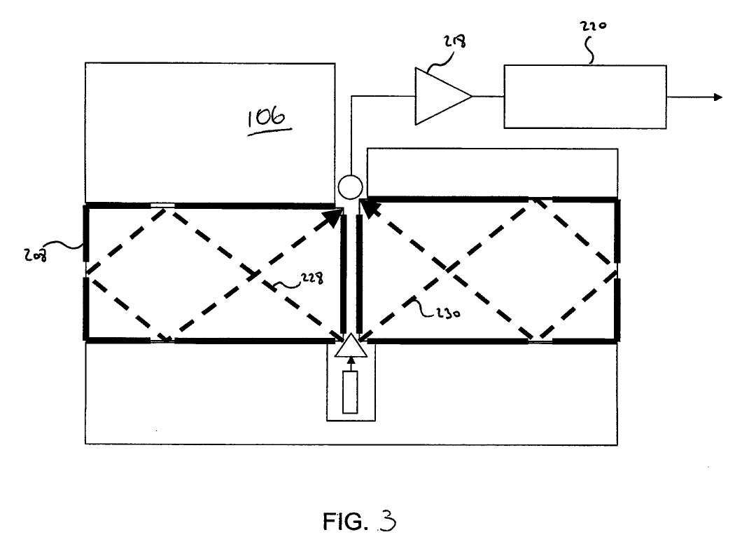

FIG. 3 is a schematic view of a loaded apparatus in accordance with the present invention,

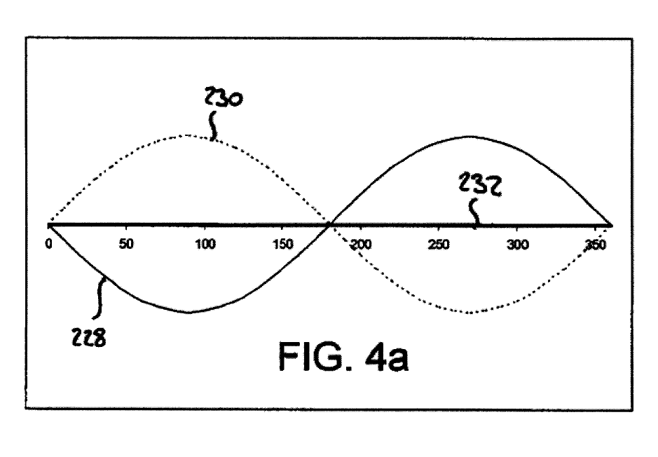

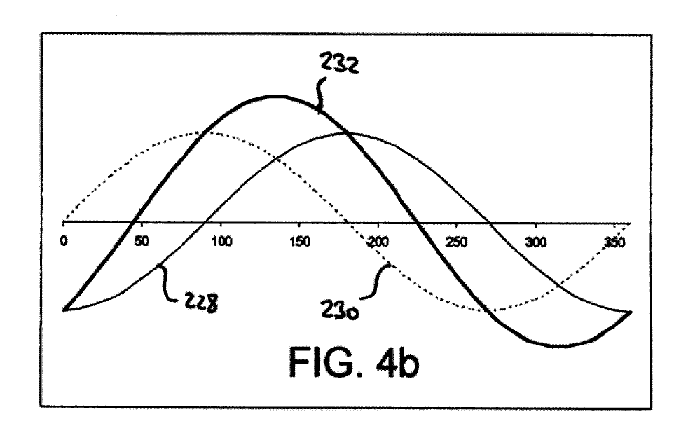

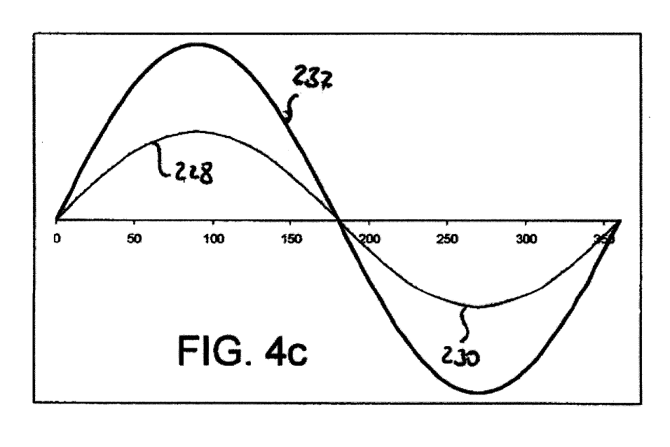

FIG. 4a is a schematic wave superposition with waves at a 180 degree phase difference,

FIG. 4b is a schematic wave superposition with waves at a 270 degree phase difference,

FIG. 4c is a schematic wave superposition with waves at a 360 degree phase difference, and

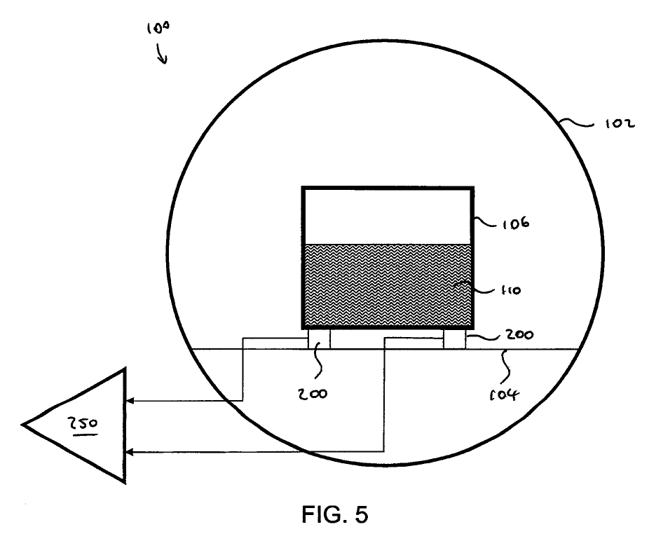

FIG. 5 is a section view of an aircraft fuselage with a fuel tank fitted with two apparatuses according to the present invention.

Referring to FIG. 1, an aircraft 100 comprises a fuselage 102 having a floor 104 situated therein. A fuel tank 106 is located within the fuselage 102 and rests on the floor 104. The fuel tank 106 is generally cuboid in shape and is sealed with the exception of vents, filling and emptying ports (not shown). The fuel tank rests on four feet 108 and contains a quantity of fuel 110 to be measured.

Turning to FIG. 2, a weight measurement apparatus 200 in accordance with the present invention is shown. The apparatus comprises a support 202 having a first support portion 204 and a second support portion 206. A first solid element 208 is positioned on the first support portion 204. A second solid element 210 is positioned on the second support portion 206. Each of the solid elements 208, 210 is constructed from the same material and both are substantially identical in shape. Each of the solid elements 208, 210 is constructed from a material at least partially transparent to electromagnetic radiation (EMW), for example borosilicate.

Preferably, the material has a Poisson's ratio near zero to avoid strain transverse to an applied load for reasons which will become clear below.

An electromagnetic wave (EMW) emitter in the form of a laser 212 is positioned between the support portions 204, 206 which directs electromagnetic wave (EMW) radiation in the form of laser light to a splitter 214. A laser detector 216 is positioned above and between the solid elements 208, 210 and is connected to a phase detector 218 and subsequently to a computer 220.

In use, a fuel tank 106 (shown schematically) is positioned on top of the first sold element 208 such that at least part of its weight forms a load path through the first solid element 208 to the floor 104. At this stage, the tank 106 is empty. A reference weight 224 may be placed on the second solid element 210 to achieve the required calibration (i.e. the desired initial phase difference as described below).

As can be seen in FIG. 2, when activated the laser 212 emits a light beam 226 towards the splitter 214. The splitter splits the light into two wave paths 228, 230. Each wave path is reflected off the walls of the elements 208, 210 to define a convoluted path to the detector 216. Reflection occurs due to total internal reflection, and the dimensions of the splitter 214 and elements 208, 210 are selected to ensure that the angle of the wave path incident upon the element walls is sufficient to ensure total internal reflection. By total internal reflection, we mean reflection sufficient to reflect the majority of the energy of the incident wave.

In the embodiment of FIG. 2, the dimensions of the elements 208, 208 and the relative weights of the empty tank 106 and reference weight 224 are selected such that the wave paths 228, 230 arrive at the detector 216 with a phase difference of 180 degrees—i.e. in antiphase. The superposition of the waveforms 232 is shown in FIG. 4a.

This is possible because as the solid elements 208, 210 deform under the relative weights of the tank 106 and reference weight 224, the wave paths vary in length-specifically, if one element is under more strain than the other, then that light path has a different distance to travel and will arrive at the detector out of phase with the other. Therefore in this case, the wave paths cancel each other out and provide a zero signal to the detector 218 and computer 220.

In FIG. 3, the fuel tank has been filled with fuel. The element 208 becomes more compressively strained than in the condition shown in FIG. 2 and as such the wave path 228 becomes shorter than the wave path 230. As a result, the phase angle changes. The superposition of the waveforms 232 is shown in FIG. 4b.

The phase detector 218 operates by determining the maximum amplitude of the superimposed waveforms, which will increase from the zero position of FIG. 2. The computer 220 can therefore look up the phase shift against a look up table of phase shift vs. weight and determine the weight of the fuel.

It will be understood that the maximum relative phase shift tolerable is 180 degrees (as shown in FIG. 4c), as once the phase shift in the above example has exceeded 180 degrees (a phase difference of 360 degrees in total), the maximum amplitude of the superimposed wave paths will start to decrease. Therefore the stiffness and dimensions of the first solid element 208 have to be chosen such that the maximum deformation experienced results in a phase shift no greater than 180 degrees—i.e. the maximum change in the length of the first wave path 228 should be no greater than half the wavelength of the laser light.

With visible laser light with a wavelength of 0.4 microns, the maximum change in the length of the wave path should be 0.2 microns.

Turning to FIG. 5, in practice a number of the above devices 200 are implemented around the base of the tank 106 and the readings collated by a computer 250 to determine the overall weight of the fuel 110.

In flight, the aircraft will experience various accelerations and corresponding forces which may affect the fuel level measurements. A flight control computer can account for these forces and calculate the true level. Typically, the accelerations can be obtained from the aircraft's navigation system or from a 3-axis accelerometer.

Variations of the above embodiments fall within the scope of the present invention.

The object to be measured does not have to be an aircraft fuel tank.

The solid elements do not have to be identical in shape, as the second solid element acts only as a control element from which the phase shift is measured.

The EMW radiation does not have to be laser light, and may be any detectable radiation with a waveform able to be reflected and traverse a solid material. The radiation does not have to be visible to the naked eye.

The light splitter may be a prism. Alternatively two sources of light or an alternative type of light splitter may be used, in which the phase coherence of the waves is maintained.

The light path does not have to be convoluted, as long as it changes length with deformation of the first solid element.

Total internal reflection does not have to be used. The elements may have mirrored walls, or mirrored elements positioned on them at the positions where the wave paths will hit.

The computer may be arranged to calculate the fuel weight using an algorithm rather than a look up table.

1. An aircraft fuel tank weight measurement apparatus comprising:
a first element defining a load path for an aircraft fuel tank,
an electromagnetic wave emitter and an electromagnetic wave detector arranged such that a first electromagnetic wave passes from the electromagnetic wave emitter to the electromagnetic wave detector through the first element to define a first wave path,
the detector arranged to detect a change in length of the first wave path caused by a dimensional change of the first element.

2. An aircraft fuel tank weight measurement apparatus according to claim 1 comprising a second element arranged such that a second electromagnetic wave passes through the second element, the detector arranged to detect a phase shift between the first and second waves.

3. An aircraft fuel tank weight measurement apparatus according to claim 2 in which the second electromagnetic wave is generated by the electromagnetic wave emitter.

4. An aircraft fuel tank weight measurement apparatus according to claim 3 comprising a splitter arranged to generate the first and second waves from the electromagnetic wave emitter.

5. An aircraft fuel tank weight measurement apparatus according to claim 2 in which the first and second elements are substantially identical.

6. An aircraft fuel tank weight measurement apparatus according to claim 2 in which the detector detects the maximum amplitude of a superimposed waveform of the first and second electromagnetic waves.

7. An aircraft fuel tank weight measurement apparatus according to claim 1 in which the first element is solid.

8. An aircraft fuel tank weight measurement apparatus according to claim 2 in which the second element is solid.

9. An aircraft fuel tank weight measurement apparatus according to claim 1 in which the first wave is reflected off a side wall of the first solid element.

10. An aircraft fuel tank weight measurement apparatus according to claim 9 in which the first wave is reflected off a side wall of the first element by total internal reflection.

11. An aircraft fuel level measurement device comprising a plurality of aircraft fuel tank weight measurement apparatus according to claim 1, the plurality of aircraft fuel tank weight measurement apparatuses supporting the weight of a fuel tank.

12. An aircraft fuel level measurement device according to claim 11 in which the deformation of the first element of the or each weight measurement apparatus under a full fuel load results in a change of length of the first electromagnetic wave path of less than or equal to half the wavelength of the first electromagnetic wave.

13. A method of measuring the weight of an aircraft fuel tank, comprising the steps of:
providing an aircraft fuel tank,
providing a first element at least partially supporting the aircraft fuel tank,
providing an electromagnetic wave emitter and an electromagnetic wave detector,
positioning the electromagnetic wave emitter and the electromagnetic wave detector such that a first electromagnetic wave from the electromagnetic wave emitter to the electromagnetic wave detector passes through the first element,
using the detector to determine a pre-load characteristic of the first electromagnetic wave,
changing the weight of the aircraft fuel tank,
using the detector to determine a post-load characteristic of the first electromagnetic wave,
determining the phase shift between the pre- and post-load characteristics resulting from a dimensional change of the first solid element to establish the change in weight of the aircraft fuel tank.

14. A method of measuring the weight of an aircraft fuel tank to be weighed according to claim 13, comprising the additional steps of:
providing a second element,
positioning the electromagnetic emitter and the electromagnetic detector such that a second electromagnetic wave from the electromagnetic emitter to the electromagnetic detector passes through the second element,
and the step of determining the phase shift comprises the step of comparing the phase difference between the first and second waves.

15-17. (canceled)
